(19) United States
(12) Patent Application Publication
(10) Pub. No.: US 2025/0330733 A1
(43) Pub. Date: Oct. 23, 2025

(54) COMMUNICATION APPARATUS, NETWORK CONFIGURATION SYSTEM, AND COMMUNICATION METHOD

(71) Applicants: NEC Corporation, Tokyo (JP); National University Corporation Tokai National Higher Education and Research System, Nagoya-shi (JP)

(72) Inventors: Shigeyuki YANAGIMACHI, Tokyo (JP); Hiroshi Hasegawa, Aichi (JP); Yojiro Mori, Aichi (JP); Hayato Yuasa, Aichi (JP)

(73) Assignees: NEC Corporation, Tokyo (JP); National University Corporation Tokai National Higher Education and Research System, Nagoya-shi (JP)

(21) Appl. No.: 19/020,555

(22) Filed: Jan. 14, 2025

(30) Foreign Application Priority Data
Apr. 18, 2024 (JP) 2024-067236

(51) Int. Cl. H04Q 11/00

(52) U.S. Cl. CPC H04Q 11/0062; H04Q 11/0005; H04Q 2011/0052

(57) ABSTRACT

A communication apparatus, a network configuration system, and a communication method that are capable of improving transmission performance are provided. The communication apparatus includes a node included in a network configuration in an optical network. The node includes layers of two or more kinds of different switch granularities, and connects the layers with respect to a node of another adjacent communication apparatus. The node includes a wavelength cross-connect layer including a wavelength cross-connect switch configured to perform switching in a wavelength unit, and a fiber cross-connect layer including a fiber cross-connect switch configured to perform switching in a fiber unit. Each of the wavelength cross-connect switch and the fiber cross-connect switch may be connected with respect to the node of the another adjacent communication apparatus.

### INCORPORATION BY REFERENCE

This application is based upon and claims the benefit of priority from Japanese patent application No. 2024-067236, filed on Apr. 18, 2024, the disclosure of which is incorporated herein in its entirety by reference.

### TECHNICAL FIELD

The present disclosure relates to a communication apparatus, a network configuration system, a communication method, and a communication program.

### BACKGROUND ART

Japanese Unexamined Patent Application Publication No. 2002-262319 describes a network of an optical cross-connect system.

Japanese Unexamined Patent Application Publication No. 2002-262319

Japanese Unexamined Patent Application Publication No. 2003-198485

Japanese Unexamined Patent Application Publication No. 2013-085010

Japanese Unexamined Patent Application Publication No. 2004-072238

Japanese Unexamined Patent Application Publication No. 2001-045052

Improving transmission performance in a network has been desired.

### SUMMARY

An example object of the present disclosure is made in order to solve the above-described problem, and is to provide a communication apparatus, a network configuration system, a communication method, and a communication program that are capable of improving transmission performance.

In a first example aspect according to the present disclosure, a communication apparatus includes a node included in a network configuration in an optical network. The node includes layers of two or more kinds of different switch granularities, and connects the layers with respect to a node of another adjacent communication apparatus.

In a second example aspect according to the present disclosure, a network configuration system includes a plurality of communication apparatuses including a node included in a network configuration in an optical network. The node of each communication apparatus includes layers of two or more kinds of different switch granularities, and the node of a first communication apparatus connects the layers with respect to the node of an adjacent second communication apparatus.

In a third example aspect according to the present disclosure, a communication method includes a step of connecting layers between a node being included in a network configuration in an optical network and including the layers of two or more kinds of different switch granularities, and another adjacent node.

In a fourth example aspect according to the present disclosure, a communication program causes a computer to execute a step of connecting layers between a node being included in a network configuration in an optical network and including the layers of two or more kinds of different switch granularities, and another adjacent node.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram illustrating a concept of a wavelength cross-connect system and a network configuration according to the present disclosure;

FIG. 2 is a diagram illustrating a concept of a hierarchical cross-connect system according to the present disclosure;

FIG. 3 is a schematic diagram illustrating a wavelength group path and a routing of a wavelength path in the hierarchical cross-connect system according to the present disclosure;

FIG. 4 is a diagram illustrating a network configuration in the hierarchical cross-connect system according to the present disclosure;

FIG. 5 is a block diagram illustrating a communication apparatus according to the present disclosure;

FIG. 6 is a flowchart illustrating a communication method according to the present disclosure;

FIG. 7 is a block diagram illustrating the communication apparatus according to the present disclosure;

FIG. 8 is a diagram illustrating a network concept of an associated hierarchical cross-connect system according to the present disclosure;

FIG. 9 is a diagram illustrating a network concept of a hierarchical different granularity routing optical network system according to the present disclosure;

FIG. 10 is a diagram illustrating a network configuration according to the present disclosure;

FIG. 11 is a diagram illustrating an operation of an optical path in the network configuration according to the present disclosure;

FIG. 12 is a diagram illustrating an operation of an optical path in the network configuration according to the present disclosure;

FIG. 13 is a flowchart illustrating an operation of an optical path in the network configuration according to the present disclosure;

FIG. 14 is a graph illustrating a port utilization rate in a case where a certain number of optical paths are generated according to the present disclosure, a horizontal axis indicating a topology model, and a vertical axis indicating a port utilization rate;

FIG. 15 is a graph illustrating the number of passing stages of WXC in COST266 according to the present disclosure, a horizontal axis indicating the number of passing stages, and a vertical axis indicating the number of optical paths in a case where normalization is performed assuming that the total number of optical paths is 1;

FIG. 16 is a diagram illustrating a network concept of a hierarchical different granularity routing optical network system according to the present disclosure;

FIG. 17 is a diagram illustrating a network configuration according to the present disclosure;

FIG. 18 is a diagram illustrating an operation of an optical path in the network configuration according to the present disclosure;

FIG. 19 is a flowchart illustrating an operation of an optical path in the network configuration according to the present disclosure;

FIG. 20 is a diagram illustrating a network configuration according to the present disclosure; and

FIG. 21 is a diagram illustrating an operation of an optical path in the network configuration according to the present disclosure.

### EXAMPLE EMBODIMENT

First, a task newly found by the inventor is described. This makes example embodiments more clear. Note that, the task newly found by the inventor is also within the range of the technical idea of the example embodiments.

### Task Newly Found by Inventor

In recent years, a traffic flowing through a network has continued rapid growth due to rapid spread of mobile terminals represented by smartphones, and communication of large capacity data such as a high-precision image by advancement of a terminal. According to a survey by the Ministry of Internal Affairs and Communications in Japan, the total download traffic of broadband subscribers in Japan in the year of 2022 is about 29.2 Tbps, and continues to grow by a ratio of about 23.7% per year. Growth of a traffic in the future is also expected.

In contrast, in a core network supporting large capacity communication, development of a technique for meeting needs for achieving a large capacity, as exemplified by an advanced modulation system such as a wavelength division multiplexing (hereinafter, referred to as WDM) technique in which a plurality of optical signals of different wavelengths are multiplexed into one optical fiber for transmission, dual polarization differential quadrature phase shift keying (DP-QPSK), and 16-quadrature amplitude modulation (16-QAM) has been progressing. Further, accompanied by progress of 5G services in wireless communication, not only achieving a large capacity but also needs for low latency of a network has increasing.

To meet these needs, in recent years, in an innovative optical and wireless network (IOWN) concept led by Nippon Telegraph and Telephone Corporation (NTT), an all-photonics network (hereinafter, referred to as an APN) for achieving a large-capacity and low-latent network has been proposed. In the APN, unlike a network accompanying electrical conversion at a switching node, a signal is transmitted as light itself in all paths. Therefore, not only large capacity communication is enabled without constraints by a capacity of an electrical switch (hereinafter, referred to as an electrical SW), but also low latency can be achieved without a delay due to electrical conversion.

In an APN as described above, there is a task that is not present in a network based on an electrical SW. In a network based on an electrical SW, for example, one optical path of 100 Gbps, for example, 10 Gbps, 1 Gbps, or the like can be shared among a large number of users. However, in an APN, one user occupies one optical path. Specifically, a large amount of wavelength resources are required to accommodate a large number of users, and consequently, a size of an optical switch configured to control a route also increases.

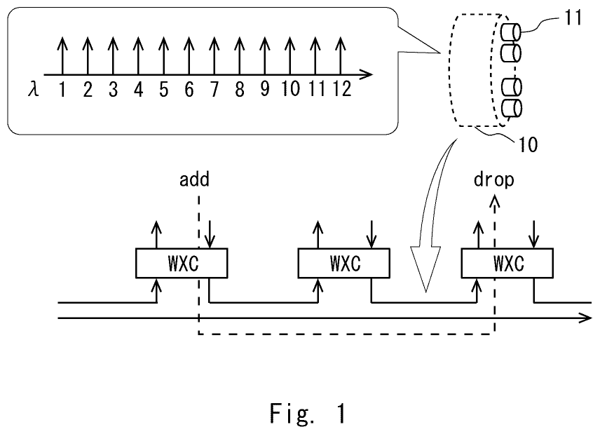

FIG. 1 is a diagram illustrating a concept of a wavelength cross-connect (wavelength XC, hereinafter, referred to as WXC) system and a network configuration according to the present disclosure. As illustrated in FIG. 1, wavelengths from λ1 to λ12 are individually accommodated in an optical fiber 10, as an optical path 11. WXC is disposed at each node. WXC performs adding and dropping in a wavelength unit, and route switching. In a case of the present system, an increase in wavelength resources is directly connected to an increase in the size of WXC, and leads to an increase in optical loss and an increase in cost. In contrast, a hierarchical cross-connect system has been proposed.

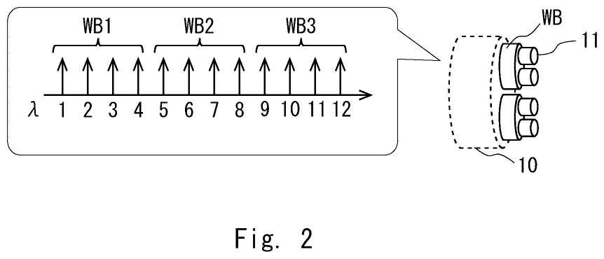

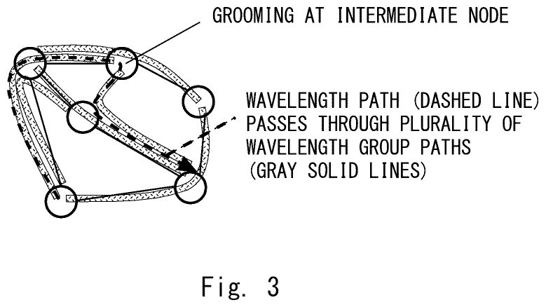

FIG. 2 is a diagram illustrating a concept of a hierarchical cross-connect system according to the present disclosure. FIG. 3 is a schematic diagram illustrating a wavelength group path, and a routing of a wavelength path in the hierarchical cross-connect system according to the present disclosure. As illustrated in FIG. 2, in the hierarchical cross-connect system, wavelengths from λ1 to λ12 are collected into a plurality of wavelength bands WB1 to WB3. For example, in FIG. 2, wavelengths λ1 to λ4 are collected into the wavelength band WB1, wavelengths λ5 to λ8 are collected into the wavelength band WB2, and wavelengths λ9 to λ12 are collected into the wavelength band WB3. Further, in the hierarchical cross-connect system, switching is performed in a wavelength band WB unit. However, switching in a wavelength unit is required for wavelength transfer between wavelength bands WBs, and adding and dropping. Therefore, switching in a wavelength unit is also enabled by disposing small-size WXC at each node (grooming function). In this way, the hierarchical cross-connect system is a configuration in which a plurality of hierarchical paths (a wavelength group path and a wavelength path) are introduced, and reduction of the number of switch elements is enabled because switching is performed in a wavelength band unit. As illustrated in FIG. 3, a wavelength path (dashed line) passes through a plurality of wavelength group paths (solid lines).

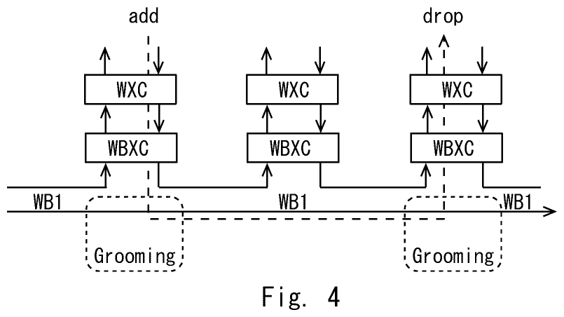

FIG. 4 is a diagram illustrating a network configuration in the hierarchical cross-connect system according to the present disclosure. As illustrated in FIG. 4, in the hierarchical cross-connect system, each node has a tandem configuration of WXC and wavelength band cross-connect (waveband XC, hereinafter, referred to as WBXC). Adjacent nodes are connected between WBXCs. As an operation of each optical path, an optical path to be added is connected to WBXC from WXC at the node, and transferred to an adjacent node via WBXC. Further, an optical path to be dropped is dropped from WBXC at the node via WXC. Further, an optical path that passes through the node passes through only WBXC.

Further, in the hierarchical cross-connect system, in a case where wavelength interchange between wavelength bands is not present, an optical path passes through only WBXC. In a case where interchange of an optical path between wavelength bands is present, the hierarchical cross-connect system can be achieved by performing grooming processing by WXC. An optical path of 2 hops passes through four cross-connects. In contrast, a network of wavelength cross-connect passes through three cross-connects. Configuring a hierarchical cross-connect system as described above enables to reduce a total switch size of WXC and WBXC, as compared with a wavelength cross-connect system, although WBXC is newly required.

As a related art document of hierarchical cross-connect, a hierarchical cross-connect system of WXC and WBXC is disclosed in Japanese Unexamined Patent Application Publication No. 2002-262319, Japanese Unexamined Patent Application Publication No. 2003-198485, and Japanese Unexamined Patent Application Publication No. 2013-085010. Further, a hierarchical cross-connect system of WXC and fiber cross-connect (fiber XC, hereinafter, referred to as FXC) is disclosed in Japanese Unexamined Patent Application Publication No. 2004-072238. Further, as hierarchization of different types of switches, a hierarchical system of a router (electrical SW) and an optical switch is disclosed in Japanese Unexamined Patent Application Publication No. 2001-045052. Unlike the above-described two related art documents, Japanese Unexamined Patent Application Publication No. 2001-045052 has one object of reducing the number of ports of an expensive router, although the document describes combination of an optical switch and an electrical SW.

Note that, by configuring a hierarchical cross-connect system from a wavelength cross-connect system, an advantageous effect of reducing a total switch size of WXC and WBXC can be expected. However, in both of the systems, an optical path passes through WXC and WBXC in which band narrowing occurs. Therefore, a transmission characteristic may be deteriorated.

One of objects of the present disclosure is to reduce a total switch size of WXC and WBXC, as compared with a wavelength routing system and a hierarchical cross-connect system, even if the number of wavelengths increases in an APN, and to suppress deterioration of a transmission characteristic by reduction of the number of passing stages of WXC and WBXC.

A first problem of an associated technique such as Japanese Unexamined Patent Application Publication No. 2002-262319, Japanese Unexamined Patent Application Publication No. 2003-198485, Japanese Unexamined Patent Application Publication No. 2013-085010, Japanese Unexamined Patent Application Publication No. 2004-072238, and Japanese Unexamined Patent Application Publication No. 2001-045052 is an increase in switch size due to an increase in wavelength resources in an APN. A reason for this is that a size of WXC increases in wavelength cross-connect. Also in a hierarchical cross-connect system in which reduction of a size of WXC is expected, reduction of a total switch size of WXC and WBXC is limited.

A second problem of an associated technique such as Japanese Unexamined Patent Application Publication No. 2002-262319, Japanese Unexamined Patent Application Publication No. 2003-198485, Japanese Unexamined Patent Application Publication No. 2013-085010, Japanese Unexamined Patent Application Publication No. 2004-072238, and Japanese Unexamined Patent Application Publication No. 2001-045052 is deterioration of transmission performance due to an increase in wavelength resources in an APN. A reason for this is that an optical path passes through a large number of WXCs and WBXCs in which band narrowing occurs.

One of objects of the present disclosure has been made to solve the above-described problems, and particularly, is to reduce a size of a wavelength cross-connect switch regarding a network configuration system and a control system in an APN, and to improve transmission performance by reduction of the number of passing stages of a wavelength cross-connect switch.

A node configuring a network of the present disclosure is configured of two layers being a WXC layer configured to perform switching in a wavelength unit, and an FXC layer configured to perform switching in a fiber unit. A switch of each layer is connected to each switch of the two layers between adjacent nodes. That is, WXC at a node is connected to WXC and FXC at an adjacent node. FXC at a node is connected to WXC and FXC at an adjacent node.

Further, as another technique, each node may be configured of three layers being a WXC layer configured to perform switching in a wavelength unit, a WBXC layer configured to perform switching in a wavelength band unit, and an FXC layer configured to perform switching in a fiber unit. That is, a switch of each layer is connected to each switch of any layer between adjacent nodes.

Further, as another technique, each node may include a wavelength converter at a previous stage of WXC. That is, each node may include a first wavelength filter, a second wavelength filter, and a wavelength converter. The first wavelength filter separates an input from WXC at a previous node into a wavelength for which wavelength conversion is necessary, and a through wavelength. The second wavelength filter separates an input from FXC at a previous node into a wavelength for which wavelength conversion is necessary, and a through wavelength. The wavelength converter converts the wavelength separated by the first wavelength filter and a second wavelength filter, and for which wavelength conversion is necessary. Each node includes a wavelength converter, and connects each through wavelength to WXC.

A first advantageous effect of the present disclosure is that a switch size can be reduced, even if an increase in wavelength resources increases in an APN.

A second advantageous effect of the present disclosure is that deterioration of transmission performance can be prevented, even if wavelength resources increase in an APN.

### OVERVIEW OF EXAMPLE EMBODIMENT

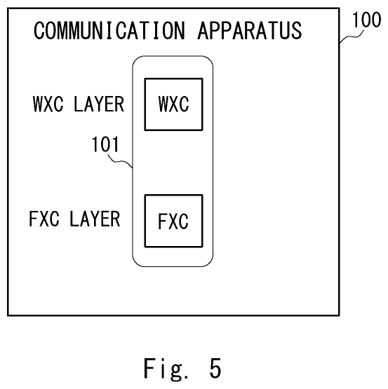

Next, an overview of an example embodiment is described. FIG. 5 is a block diagram illustrating a communication apparatus 100 according to the present disclosure. As illustrated in FIG. 5, the communication apparatus 100 includes a node 101. In the following description, there is a case where the communication apparatus 100 is described as the node 101. The node 101 is included in a network configuration in an optical network. The node 101 includes layers of two or more kinds of different switch granularities. The plurality of layers include, for example, a wavelength cross-connect layer and a fiber cross-connect layer. Note that, the plurality of layers may further include a wavelength band cross-connect layer. The node 101 connects the layers with respect to a node 101 of another adjacent communication apparatus 100.

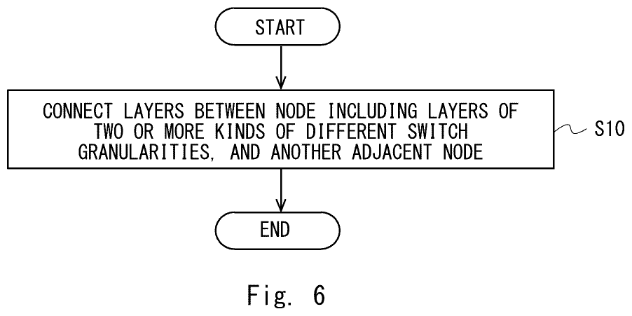

Next, a communication method according to the present disclosure is described. FIG. 6 is a flowchart illustrating the communication method according to the present disclosure. As illustrated in FIG. 6, the communication method includes step S10 of connecting layers between a node 101 included in a network configuration in an optical network, the node 101 including the layers of two or more kinds of different switch granularities, and another adjacent node 101.

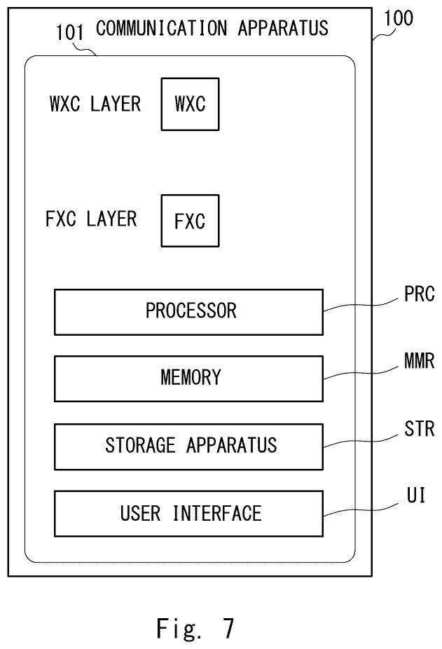

The above-described communication apparatus 100 may include, for example, an information processing apparatus such as a microcomputer, a server, and a personal computer (PC). FIG. 7 is a block diagram illustrating the communication apparatus 100 according to the present disclosure. As illustrated in FIG. 7, the node 101 of the communication apparatus 100 may further include a processor PRC, a memory MMR, a storage device STR, and a user interface UI. The storage device STR stores processing to be performed by each configuration of the communication apparatus 100, as a program. The processor PRC causes the program from the storage device STR to be read in the memory MMR, and executes the program. Thus, the processor PRC achieves a function of each configuration in the communication apparatus 100. The user interface UI may include an input apparatus such as a keyboard, a mouse, and an imaging apparatus, and an output apparatus such as a display, a printer, and a speaker.

Each configuration included in the communication apparatus 100 may be achieved by dedicated hardware. Further, a part or the whole of each constituent element may be achieved by a general-purpose or dedicated circuitry, a processor PRC, and the like, or combination of these. These may be configured of a single chip, or may be configured of a plurality of chips to be connected via a bus. A part or the whole of each constituent element may be achieved by combination of the above-described circuitry and the like, and a program. Further, as the processor PRC, a central processing unit (CPU), a graphics processing unit (GPU), a field-programmable gate array (FPGA), a quantum processor (quantum computer control chip), or the like can be used.

Further, in a case where a part or the whole of each constituent element of the communication apparatus 100 is achieved by a plurality of communication apparatuses 100, circuitries, and the like, the plurality of communication apparatuses 100, the circuitries, and the like may be disposed in a concentrated manner, or may be disposed in a distributive manner. For example, the communication apparatus 100, a circuitry, and the like may be achieved as a configuration in which each is connected via a communication network by a client-server system, a cloud computing system, or the like. Further, a function of the communication apparatus 100 may be provided in the form of Software as a Service (SaaS).

According to the present example embodiment, the node 101 of the communication apparatus 100 includes layers of two or more kinds of different switch granularities. The communication apparatus 100 connects the layers with respect to a node 101 of another adjacent communication apparatus 100. Thus, the communication apparatus 100 can reduce a switch size, even if an increase in wavelength resources increases. Further, the communication apparatus 100 can suppress deterioration of transmission performance, even if wavelength resources increase. Thus, the communication apparatus 100 can improve transmission performance.

### First Example Embodiment

Next, a first example embodiment is described in details. In the following, a network configuration system of the first example embodiment is described by dividing the network configuration system into description on a configuration, and description on an operation.

### Description on Configuration

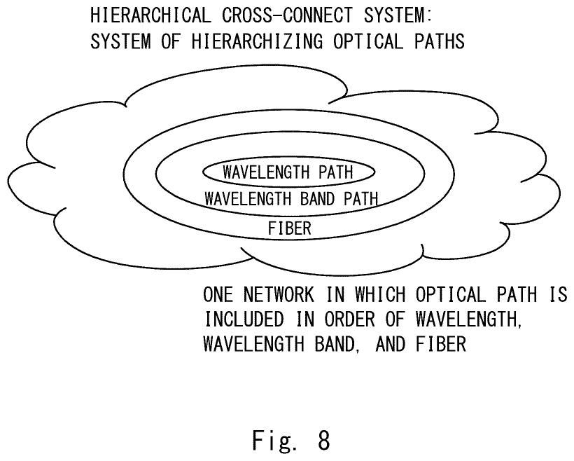

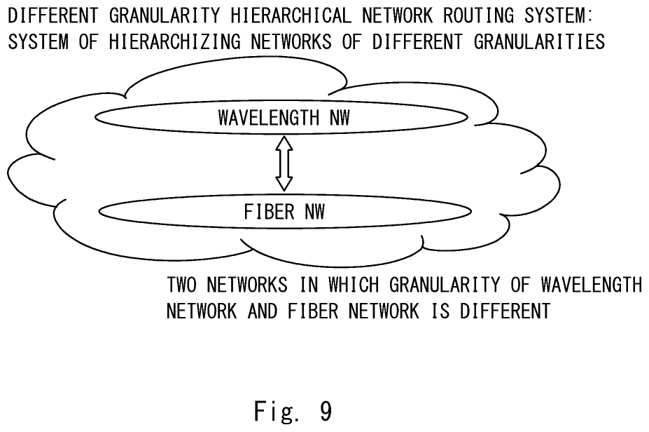

FIG. 8 is a diagram illustrating a network concept of an associated hierarchical cross-connect system according to the present disclosure. FIG. 9 is a diagram illustrating a network concept of a hierarchical different granularity routing optical network system according to the present disclosure. As illustrated in FIG. 8, the associated hierarchical cross-connect system is a system of hierarchizing optical paths. An optical path is configured of one network in which a wavelength, a wavelength band, and a fiber are included in this order. In contrast, as illustrated in FIG. 9, the hierarchical different granularity routing optical network system according to the present example embodiment is a system of hierarchizing networks of different granularities. The hierarchical different granularity routing optical network system of the present example embodiment is configured of two independent networks NWs of different granularities being a wavelength cross-connect network NW, and a fiber cross-connect network NW. Along with this, the hierarchical different granularity routing optical network system of the present example embodiment is a configuration of connecting each network NW.

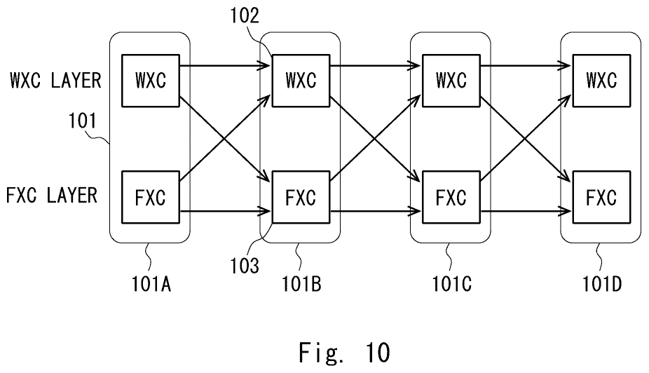

FIG. 10 is a diagram illustrating a network configuration according to the present disclosure. As illustrated in FIG. 10, a network configuration of the present example embodiment is configured in such a way that four nodes 101 (a node 101A to a node 101D) are linearly connected in a point-by-point manner. A network configuration of the present example embodiment may be connected in a shape such as a ring shape and a mesh shape. Further, as far as the number of the nodes 101 is plural, the number of the nodes 101 is not limited to four, and may be three or less, or may be four or more. Each node 101 is configured of two layers being a WXC layer configured to perform switching in a wavelength unit, and an FXC layer configured to perform switching in a fiber unit.

A switch of each layer is connected to each switch of the two layers between adjacent nodes 101. That is, a WXC 102 at the node 101A is connected to a WXC 102 and an FXC 103 at the node 101B. An FXC 103 at the node 101A is connected to the WXC 102 and the FXC 103 at the node 101B. That is, in the associated hierarchical cross-connect, connection between different layers is performed within the same node 101 (an inclusion relationship between layers is present), however, in the hierarchical cross-connect of the present example embodiment, connection between layers is not performed within a node 101 (an inclusion relationship between layers is not present).

In this way, a network configuration system of the present example embodiment includes a plurality of communication apparatuses 100 including a node 101 included in a network configuration in an optical network. The node 101 of each communication apparatus 100 includes layers of two or more kinds of different switch granularities. For example, the node 101A connects layers with respect to the adjacent node 101B.

The node 101 of each communication apparatus 100 includes a wavelength cross-connect layer, and a fiber cross-connect layer. The wavelength cross-connect layer includes a wavelength cross-connect switch configured to perform switching in a wavelength unit. The fiber cross-connect layer includes a fiber cross-connect switch configured to perform switching in a fiber unit. For example, each of a wavelength cross-connect switch and a fiber cross-connect switch at the node 101A connects an optical path with respect to the node 101B. Specifically, each of a wavelength cross-connect switch and a fiber cross-connect switch at the node 101 of the communication apparatus 100 connects an optical path with respect to the node 101 of another adjacent communication apparatus 100.

Specifically, a wavelength cross-connect switch at the node 101A switches in such a way that an optical path is connected to a wavelength cross-connect switch or a fiber cross-connect switch at the node 101B. A fiber cross-connect switch at the node 101A switches in such a way that an optical path is connected to a wavelength cross-connect switch or a fiber cross-connect switch at the node 101B.

A wavelength cross-connect switch at the node 101A does not connect an optical path to a fiber cross-connect switch at the node 101A. That is, a wavelength cross-connect switch at the node 101A does not switch in such a way that an optical path is connected to a fiber cross-connect switch at the node 101A.

### Description on Operation

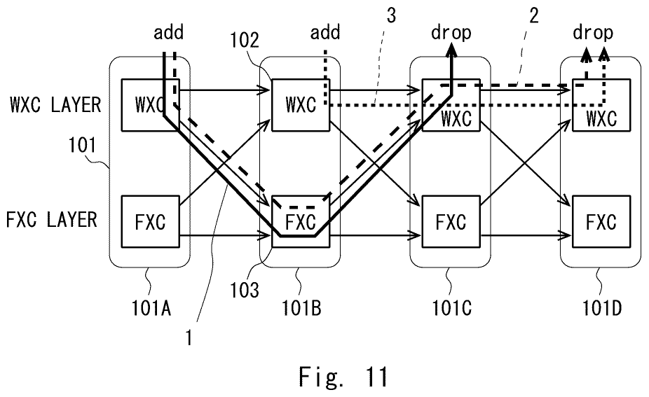

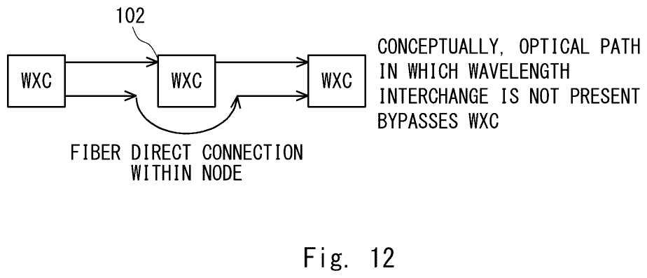

Next, an operation of an optical path in a network configuration according to the present disclosure is described with reference to FIGS. 11 to 12. FIGS. 11 to 12 are diagrams illustrating an operation of an optical path in a network configuration according to the present disclosure. FIG. 11 illustrates three optical paths 1 to 3 to describe an operation of each optical path, but the present example embodiment is not limited thereto. Further, the node 101 includes a controller configured to perform at least one of adding and dropping of the optical paths 1 to 3. The controller includes, for example, a processor PRC, but the present example embodiment is not limited thereto.

First, the optical path 1 is added at the node 101A. The optical path 1 is dropped at the node 101C. The optical path 1 is an optical path of 2 hops. Further, the optical path 2 is added at the node 101A. The optical path 2 is dropped at the node 101D. The optical path 2 is an optical path of 3 hops. Further, the optical path 3 is added at the node 101B. The optical path 3 is dropped at the node 101D. The optical path 3 is an optical path of 2 hops. As illustrated in FIG. 12, conceptually, an optical path in which wavelength interchange is not present bypasses the WXC 102.

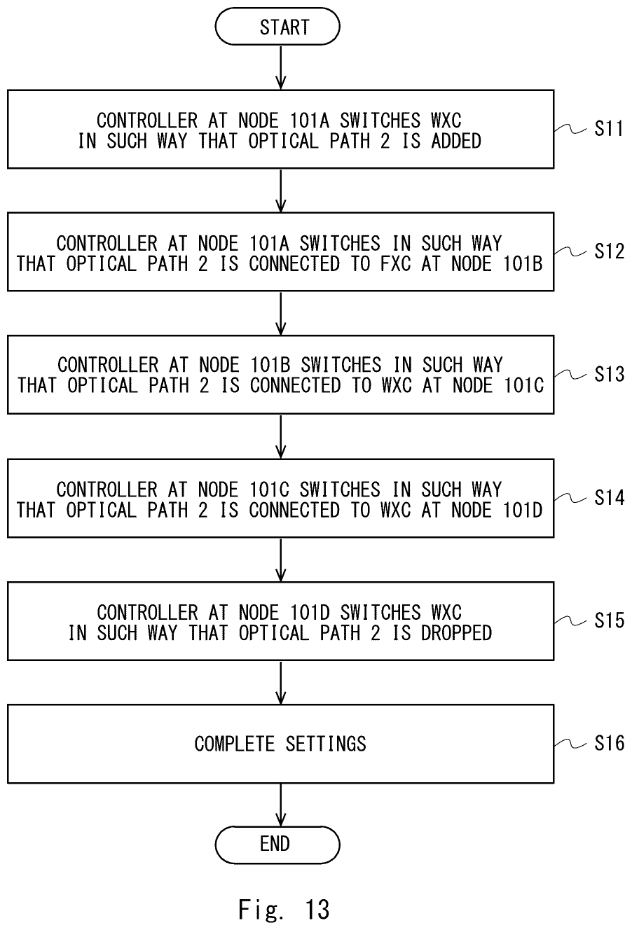

FIG. 13 is a flowchart illustrating an operation of the optical path 2 in a network configuration according to the present disclosure. FIG. 13 illustrates an operation of the above-described optical path 2. First, a controller (e.g., a processor PRC) at the node 101A controls the WXC 102 at the node 101A in such a way that the optical path 2 is added (step S11). Thus, the WXC 102 at the node 101A adds the optical path 2.

Next, the controller at the node 101A controls the WXC 102 at the node 101A in such a way that the optical path 2 is connected to the FXC 103 at the node 101B (step S12). Thus, the WXC 102 at the node 101A switches in such a way that the optical path 2 is connected to the FXC 103 at the node 101B.

Next, a controller at the node 101B controls the FXC 103 at the node 101B in such a way that the optical path 2 is connected to the WXC 102 at the node 101C (step S13). Thus, the FXC 103 at the node 101B switches in such a way that the optical path 2 is connected to the WXC 102 at the node 101C.

Next, a controller at the node 101C controls the WXC 102 at the node 101C in such a way that the optical path 2 is connected to the WXC 102 at the node 101D (step S14). Thus, the WXC 102 at the node 101C switches in such a way that the optical path 2 is connected to the WXC 102 at the node 101C.

Next, a controller at the node 101D controls the WXC 102 at the node 101D in such way that the optical path 2 is dropped (step S15). Thus, the WXC 102 at the node 101D drops the optical path 2. Next, settings are completed (step S16).

In this way, in a step of connecting layers in a communication method of the present example embodiment, each of a wavelength cross-connect switch and a fiber cross-connect switch connects an optical path with respect to another adjacent node 101.

Specifically, in a step of connecting layers, a wavelength cross-connect switch switches in such a way that the optical path 2 is connected to a wavelength cross-connect switch or a fiber cross-connect switch at another adjacent node 101. Further, a fiber cross-connect switch switches in such a way that the optical path 2 is connected to a wavelength cross-connect switch or a fiber cross-connect switch at another adjacent node 101.

In a step of connecting layers, a wavelength cross-connect switch is operated in such a way that a fiber cross-connect switch at the same node 101 and the optical path 2 are not connected to each other.

Therefore, a WXC layer and an FXC layer are operated independently of each other. The optical path 2 can transfer between layers as necessary. As illustrated in FIG. 12, conceptually, the optical path 2 in which switching in a wavelength unit, as exemplified by adding and dropping, and wavelength interchange is not required bypasses the WXC 102.

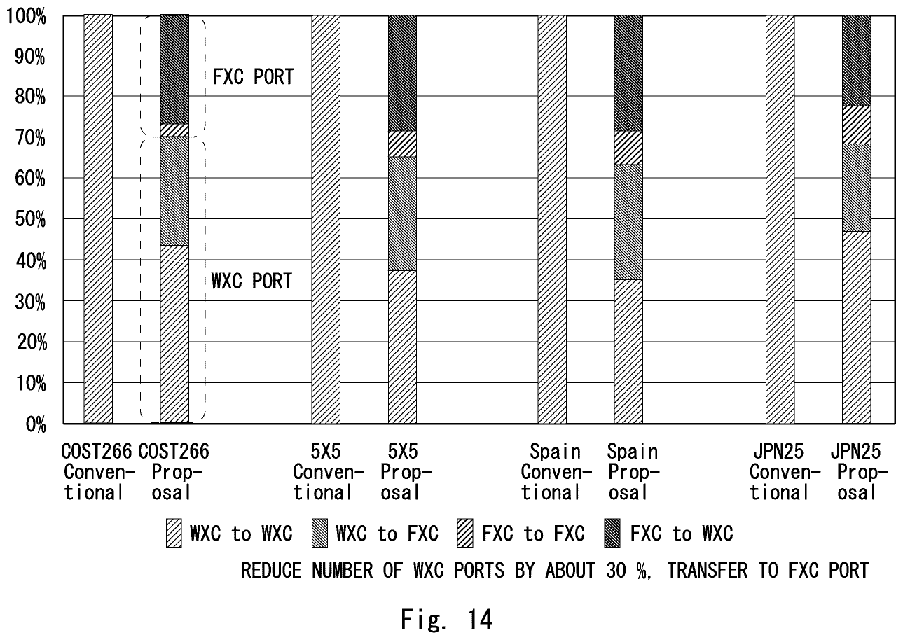

Next, a simulation result using three topology models is described. Note that, as topology models, COST266, a 5×5 lattice model, Spain, and JPN25 are used. FIG. 14 is a graph illustrating a port utilization rate in a case where a certain number of optical paths are generated according to the present disclosure, a horizontal axis indicating a topology model, and a vertical axis indicating a port utilization rate. FIG. 14 compares a case of associated wavelength cross-connect with a case where a network configuration according to the present disclosure is used, regarding each model in a horizontal axis.

In associated wavelength cross-connect, only WXC is used. Therefore, normalization is performed assuming that a case of associated wavelength cross-connect is 100%, and a ratio of the number of ports in use of WXC and FXC is indicated in a case of a network configuration according to the present disclosure. Note that, a network configuration according to the present disclosure is a 2-layer configuration of a WXC layer and an FXC layer. Therefore, a connection topology includes four patterns of WXC-WXC, WXC-FXC, FXC-FXC, and FXC-WXC. Accordingly, WXC-WXC and WXC-FXC indicate the number of ports in use of WXC, and FXC-FXC and FXC-WXC indicate the number of ports in use of FXC.

For example, in COST266, the number of ports in use of a WXC port is suppressed to about 70%, as compared with associated wavelength cross-connect. Therefore, a network configuration according to the present disclosure can reduce the number of WXC ports. Note that, an equivalent advantageous effect is acquired also in other topology models.

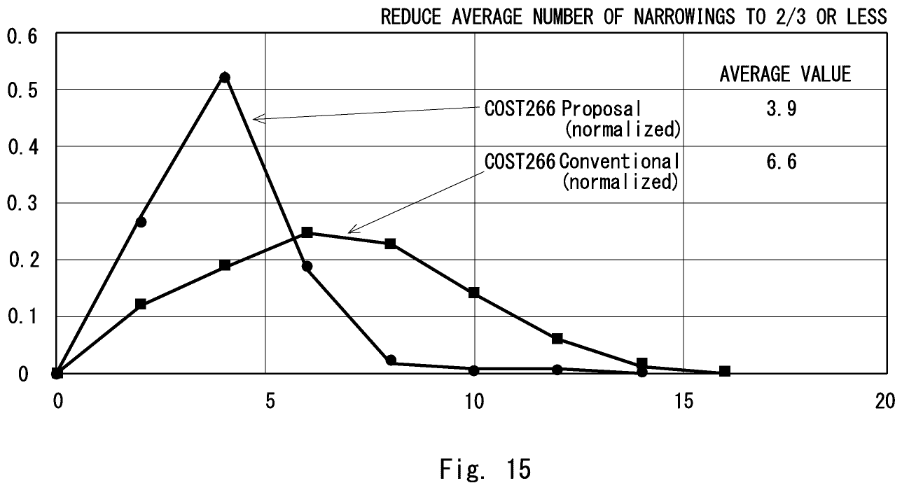

FIG. 15 is a graph illustrating the number of passing stages of WXC in COST266 according to the present disclosure. A horizontal axis indicates the number of passing stages, and a vertical axis indicates the number of optical paths in a case where normalization is performed assuming that the total number of optical paths is 1. As illustrated in FIG. 15, routing of an associated wavelength path is 6.6 stages in average. On the other hand, routing of a network configuration according to the present disclosure becomes 3.9 stages in average. In WXC, there is a case where band narrowing occurs due to a filter effect. However, in FXC, band narrowing is less likely to occur. Therefore, in a network configuration according to the present disclosure, a transmission characteristic is maintained in a satisfactory manner.

According to the present example embodiment, the node 101 includes a wavelength cross-connect layer and a fiber cross-connect layer. The node 101 connects the layers with respect to another adjacent node 101. This enables to reduce a switch size, even if an increase in wavelength resources increases. Further, it is possible to suppress deterioration of transmission performance, even if wavelength resources increase.

### Second Example Embodiment

Next, a second example embodiment is described in details. In the following, a network configuration system of the second example embodiment is described by dividing the network configuration system into description on a configuration, and description on an operation.

### Description on Configuration

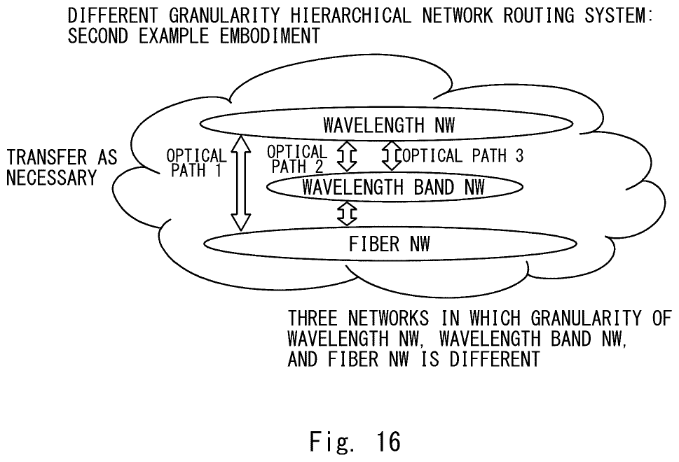

FIG. 16 is a diagram illustrating a network concept of a hierarchical different granularity optical network system according to the present disclosure. The second example embodiment of the present disclosure is a system of hierarchizing networks of different granularities. Specifically, the second example embodiment of the present disclosure is configured of three independent networks NWs of different granularities being a wavelength cross-connect network NW, a wavelength band cross-connect network NW, and a fiber cross-connect network NW. Along with this, the present example embodiment is a configuration of connecting the above-described three networks NWs.

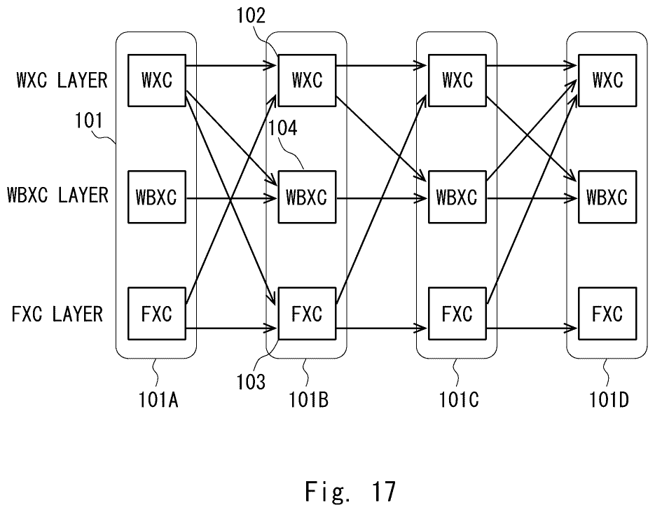

FIG. 17 is a diagram illustrating a network configuration according to the present disclosure. In FIG. 17, four nodes 101 (a node 101A to a node 101D) are linearly connected in a point-by-point manner. However, a network configuration of the present example embodiment may be connected in a ring shape and a mesh shape. Each node 101 is configured of three layers being a WXC layer configured to perform switching in a wavelength unit, a WBXC layer configured to perform switching in a wavelength band unit, and an FXC layer configured to perform switching in a fiber unit.

A switch of each layer is connected to each switch of any layer between adjacent nodes 101. For example, a WXC 102 at the node 101A is connected to a WXC 102, a WBXC 104, and an FXC 103 at the node 101B. A WBXC 104 at the node 101A is connected to the WBXC 104 at the node 101B. An FXC 103 at the node 101A is connected to the WXC 102 and the FXC 103 at the node 101B. Also each switch of any layer is connected between the node 101B and the node 101C, and between the node 101C and the node 101D. That is, in the associated hierarchical cross-connect, connection between different layers is performed within the same node (an inclusion relationship between layers is present), however, in the present example embodiment, connection between layers is not performed within the node 101 (an inclusion relationship between layers is not present).

In this way, a network configuration system of the present example embodiment includes a plurality of communication apparatuses 100 including a node 101 included in a network configuration in an optical network. The node 101 of each communication apparatus 100 includes layers of three or more kinds of different switch granularities. For example, the node 101A connects layers with respect to the adjacent node 101B.

The node 101 of each communication apparatus 100 includes a wavelength cross-connect layer, a wavelength band cross-connect layer, and a fiber cross-connect layer. The wavelength cross-connect layer includes a wavelength cross-connect switch configured to perform switching in a wavelength unit. The wavelength band cross-connect layer includes a wavelength band cross-connect switch configured to perform switching of a wavelength band being a bundle of a plurality of wavelengths. The fiber cross-connect layer includes a fiber cross-connect switch configured to perform switching in a fiber unit. For example, each of a wavelength cross-connect switch, a wavelength band cross-connect switch, and a fiber cross-connect switch at the node 101A connects an optical path with respect to the node 101B. Specifically, each of a wavelength cross-connect switch, a wavelength band cross-connect switch, and a fiber cross-connect switch at the node 101 of the communication apparatus 100 connects an optical path with respect to the node 101 of another adjacent communication apparatus 100.

Specifically, a wavelength cross-connect switch at the node 101A switches in such a way that an optical path is connected to any one of a wavelength cross-connect switch, a wavelength band cross-connect switch, and a fiber cross-connect switch at the node 101B. A wavelength band cross-connect switch at the node 101A switches in such a way that an optical path is connected to any one of a wavelength cross-connect switch, a wavelength band cross-connect switch, and a fiber cross-connect switch at the node 101B. A fiber cross-connect switch at the node 101A switches in such a way that an optical path is connected to any one of a wavelength cross-connect switch, a wavelength band cross-connect switch, and a fiber cross-connect switch at the node 101B.

A wavelength cross-connect switch at the node 101A does not connect a wavelength band cross-connect switch and a fiber cross-connect switch at the node 101A, and an optical path. Further, a wavelength band cross-connect switch at the node 101A does not connect a fiber cross-connect switch at the node 101A, and an optical path.

### Description on Operation

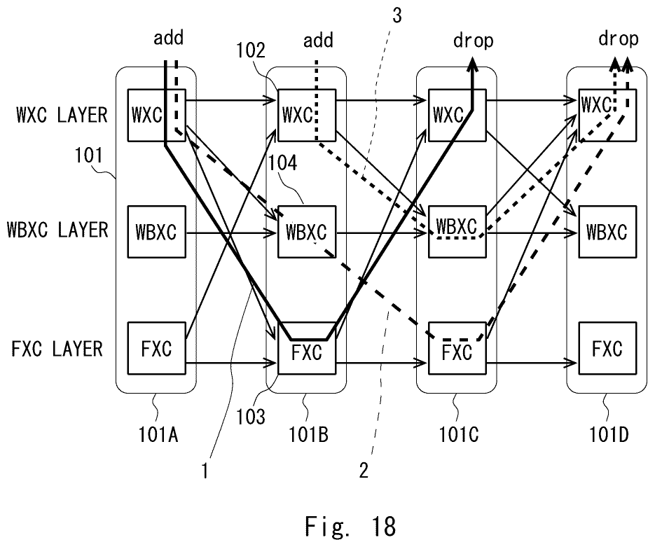

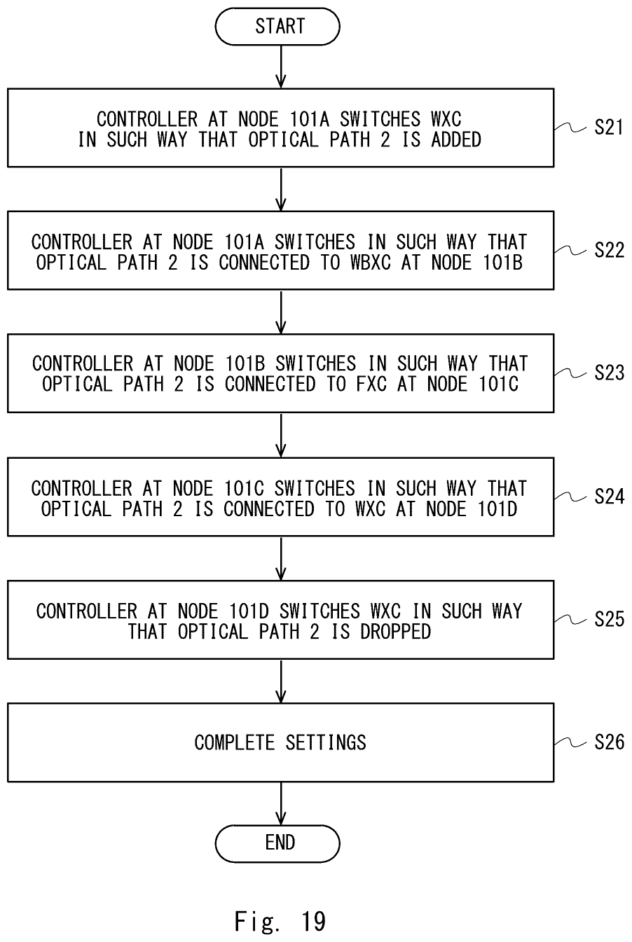

Next, an operation of an optical path in a network configuration according to the present disclosure is described with reference to FIGS. 18 to 19. FIG. 18 is a diagram illustrating an operation of an optical path in a network configuration according to the present disclosure. FIG. 18 illustrates three optical paths to describe an operation of each optical path, but the present example embodiment is not limited thereto.

First, an optical path 1 is added at the node 101A. The optical path 1 is dropped at the node 101C. The optical path 1 is an optical path of 2 hops. The optical path 1 is a path using a wavelength network and a fiber network.

Further, an optical path 2 is added at the node 101A. The optical path 2 is dropped at the node 101D. The optical path 2 is an optical path of 3 hops. The optical path 2 is a path using a wavelength network, a wavelength band network, and a fiber network. Further, an optical path 3 is added at the node 101B. The optical path 3 is dropped at the node 101D. The optical path 3 is an optical path of 2 hops. The optical path 3 is a path using a wavelength network and a wavelength band network.

FIG. 19 is a flowchart illustrating an operation of an optical path in a network configuration according to the present disclosure. FIG. 19 illustrates an operation of the above-described optical path 2. First, a controller (e.g., a processor PRC) at the node 101A controls the WXC 102 at the node 101A in such a way that the optical path 2 is added (step S21). Thus, the WXC 102 at the node 101A adds the optical path 2.

Next, the controller at the node 101A controls the WXC 102 at the node 101A in such a way that the optical path 2 is connected to the WBXC 104 at the node 101B (step S22). Thus, the WXC 102 at the node 101A switches in such a way that the optical path 2 is connected to the WBXC 104 at the node 101B.

Next, a controller at the node 101B controls the WBXC 104 at the node 101B in such a way that the optical path 2 is connected to the FXC 103 at the node 101C (step S23). Thus, the WBXC 104 at the node 101B switches in such a way that the optical path 2 is connected to the FXC 103 at the node 101C.

Next, a controller at the node 101C controls the FXC 103 at the node 101C in such a way that the optical path 2 is connected to the WXC 102 at the node 101D (step S24). Thus, the FXC 103 at the node 101C switches in such a way that the optical path 2 is connected to the WXC 102 at the node 101D.

Next, a controller at the node 101D controls the WXC 102 at the node 101D in such way that the optical path 2 is dropped (step S25). Thus, the WXC 102 at the node 101D drops the optical path 2. Next, settings are completed (step S26).

In this way, in a step of connecting layers in a communication method of the present example embodiment, each of a wavelength cross-connect switch, a wavelength band cross-connect switch, and a fiber cross-connect switch connects an optical path with respect to another adjacent node 101.

Specifically, in a step of connecting layers, a wavelength cross-connect switch switches in such a way that the optical path 2 is connected to any one of a wavelength cross-connect switch, a wavelength band cross-connect switch, and a fiber cross-connect switch at another adjacent node 101. Further, a wavelength band cross-connect switch switches in such a way that the optical path 2 is connected to any one of a wavelength cross-connect switch, a wavelength band cross-connect switch, and a fiber cross-connect switch at another adjacent node 101. Further, a fiber cross-connect switch switches in such a way that the optical path 2 is connected to any one of a wavelength cross-connect switch, a wavelength band cross-connect switch, and a fiber cross-connect switch at another adjacent node 101.

In a step of connecting layers, a wavelength cross-connect switch is operated in such a way that a wavelength band cross-connect switch and a fiber cross-connect switch at the same node 101, and the optical path 2 are not connected to each other. Further, a wavelength band cross-connect switch is operated in such a way that a fiber cross-connect switch at the same node 101, and the optical path 2 are not connected to each other.

Therefore, a WXC layer and an FXC layer are operated independently of each other. The optical path 2 can transfer between layers as necessary.

According to the present example embodiment, the node 101 includes a wavelength cross-connect layer, a wavelength band cross-connect layer, and a fiber cross-connect layer. The node 101 connects layers with respect to another adjacent node 101. This enables to reduce a switch size, even if an increase in wavelength resources increases. Further, it is possible to suppress deterioration of transmission performance, even if wavelength resources increase.

### Third Example Embodiment

Next, a third example embodiment is described in details. In the following, a network configuration system of the third example embodiment is described by dividing the network configuration system into description on a configuration, and description on an operation.

### Description on Configuration

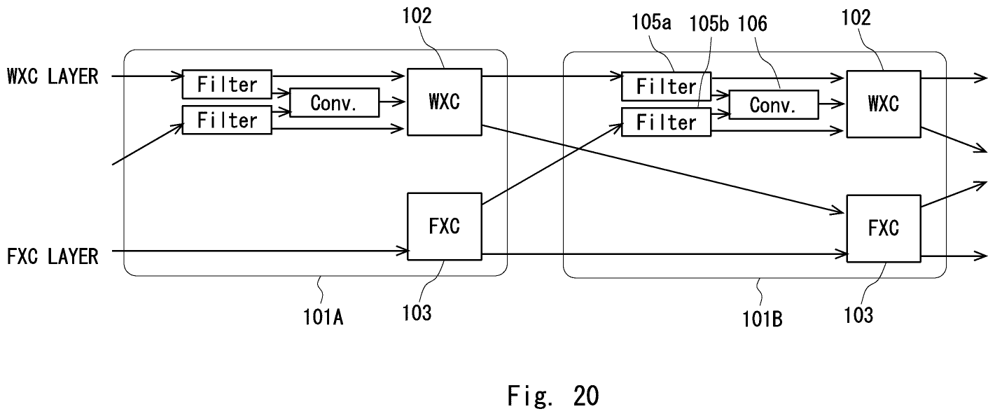

FIG. 20 is a diagram illustrating a network configuration according to the present disclosure. In FIG. 20, two nodes 101 (a node 101A to a node 101B) are linearly connected in a point-by-point manner. However, a network configuration of the present example embodiment may be connected in a ring shape and a mesh shape. Each node 101 is configured of two layers being a WXC layer configured to perform switching in a wavelength unit, and an FXC layer configured to perform switching in a fiber unit.

A switch of each layer is connected to each switch of the two layers between adjacent nodes 101. For example, in FIG. 20, a WXC 102 at the node 101A is connected to a WXC 102 and an FXC 103 at the node 101B. An FXC 103 at the node 101A is connected to the WXC 102 and the FXC 103 at the node 101B.

Further, a network configuration system of the present example embodiment includes a wavelength conversion function at a position from the WXC 102 and the FXC 103 at the node 101A of a preceding stage up to a position before input of the WXC 102 at the node 101B. Specifically, the node 101B includes a wavelength filter 105a, a wavelength filter 105b, and a wavelength converter 106. The wavelength converter 106 is disposed at a preceding stage of a wavelength cross-connect switch. The wavelength filter 105a and the wavelength filter 105b are disposed at a preceding stage of the wavelength converter 106.

The wavelength filter 105a separates an input from the WXC 102 at the node 101A into a component of a wavelength for which wavelength conversion is necessary, and a component of a through wavelength. Further, the wavelength filter 105b separates an input from the FXC 103 at the node 101A into a component of a wavelength for which wavelength conversion is necessary, and a component of a through wavelength. The wavelength converter 106 converts the wavelength separated by the wavelength filter 105a and the wavelength filter 105b, and for which wavelength conversion is necessary. Each component of the through wavelength separated by the wavelength filter 105a and the wavelength filter 105b is connected to the WXC 102.

### Description on Operation

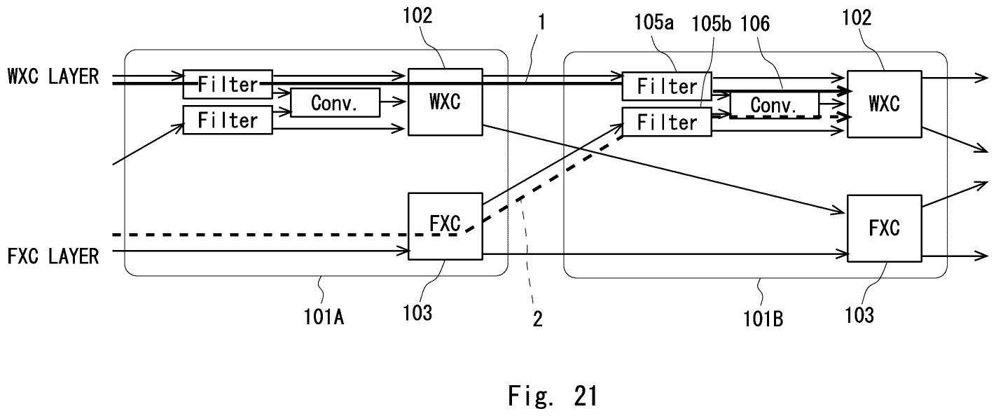

Next, an operation of an optical path in a network configuration of the third example embodiment is described with reference to FIG. 21. FIG. 21 is a diagram illustrating an operation of an optical path in a network configuration according to the present disclosure. FIG. 21 illustrates two optical paths to describe an operation of each optical path, but the present example embodiment is not limited thereto.

An optical path 1 passes through the WXC 102 at the node 101A. Further, the optical path 1 is a path to be input to the WXC 102 at the node 101B. An optical path 2 passes through the FXC 103 at the node 101A. Further, the optical path 2 is a path to be input to the WXC 102 at the node 101B.

The optical path 1 is input to the wavelength filter 105a at the node 101B. Further, the optical path 1 is separated into a component of a wavelength for which wavelength conversion is necessary, and a component of a through wavelength. Next, the component of the wavelength separated by the wavelength filter 105a, and for which wavelength conversion is necessary is converted into a desired wavelength by the wavelength converter 106, and the converted wavelength component is input to the WXC 102. Note that, the component of the through wavelength is directly input from the wavelength filter 105a to the WXC 102.

An optical path 2 is input to the wavelength filter 105b at the node 101B. Further, the optical path 2 is separated into a component of a wavelength for which wavelength conversion is necessary, and a component of a through wavelength. Next, the component of the wavelength separated by the wavelength filter 105b, and for which wavelength conversion is necessary is converted into a desired wavelength by the wavelength converter 106, and the converted wavelength component is input to the WXC 102. Note that, the component of the through wavelength is directly input from the wavelength filter 105b to the WXC 102.

Sine other operations are similar to the above-described operations of the first example embodiment, description thereof is omitted. The present configuration enables to avoid wavelength collision of an optical signal to be input to the WXC 102, and enhances utilization efficiency of wavelength resources.

Although the present disclosure has been described with reference to the example embodiments, the present disclosure is not limited to the above-described example embodiments. Various modifications that can be understood by those skilled in the art can be made to the configuration and the details of the present disclosure within the scope of the present disclosure. Then, each of the example embodiments can be appropriately combined with the other example embodiment.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures may be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

An example aspect according to the present disclosure is that a communication apparatus, a network configuration system, a communication method, and a communication program that are capable of improving transmission performance can be provided.

A part or the whole of the example embodiments described above can be described as, but not limited to, the following supplementary notes.
(Supplementary Note A1)
   A communication apparatus including a node included in a network configuration in an optical network,
   wherein the node includes layers of two or more kinds of different switch granularities, and connects the layers with respect to a node of another adjacent communication apparatus.
(Supplementary Note A2)
   The communication apparatus according to supplementary note A1, wherein
   the node includes
   a wavelength cross-connect layer including a wavelength cross-connect switch configured to perform switching in a wavelength unit, and
   a fiber cross-connect layer including a fiber cross-connect switch configured to perform switching in a fiber unit, and
   each of the wavelength cross-connect switch and the fiber cross-connect switch is connected to an optical path with respect to the node of the another adjacent communication apparatus.
(Supplementary Note A3)
   The communication apparatus according to supplementary note A2, wherein
   the wavelength cross-connect switch switches in such a way that the optical path is connected to the wavelength cross-connect switch or the fiber cross-connect switch in the another adjacent communication apparatus, and
   the fiber cross-connect switch switches in such a way that the optical path is connected to the wavelength cross-connect switch or the fiber cross-connect switch in the another adjacent communication apparatus.
(Supplementary Note A4)
   The communication apparatus according to supplementary note A2, wherein the wavelength cross-connect switch is configured in such a way that the fiber cross-connect switch and the optical path are not connected to each other.
(Supplementary Note A5)
   The communication apparatus according to supplementary note A1, wherein
   the node includes
   a wavelength cross-connect layer including a wavelength cross-connect switch configured to perform switching in a wavelength unit,
   a wavelength band cross-connect layer including a wavelength band cross-connect switch configured to perform switching of a wavelength band being a bundle of a plurality of wavelengths, and
   a fiber cross-connect layer including a fiber cross-connect switch configured to perform switching in a fiber unit, and
   each of the wavelength cross-connect switch, the wavelength band cross-connect switch, and the fiber cross-connect switch is connected to an optical path with respect to the node of the another adjacent communication apparatus.
(Supplementary Note A6)
   The communication apparatus according to supplementary note A5, wherein
   the wavelength cross-connect switch switches in such a way that the optical path is connected to any one of the wavelength cross-connect switch, the wavelength band cross-connect switch, and the fiber cross-connect switch in the another adjacent communication apparatus,
   the wavelength band cross-connect switch switches in such a way that the optical path is connected to any one of the wavelength cross-connect switch, the wavelength band cross-connect switch, and the fiber cross-connect switch in the another adjacent communication apparatus, and
   the fiber cross-connect switch switches in such a way that the optical path is connected to any one of the wavelength cross-connect switch, the wavelength band cross-connect switch, and the fiber cross-connect switch in the another adjacent communication apparatus.
(Supplementary Note A7)
   The communication apparatus according to supplementary note A5, wherein
   the wavelength cross-connect switch is configured in such a way that the optical path is not connected to the wavelength band cross-connect switch and the fiber cross-connect switch, and
   the wavelength band cross-connect switch is configured in such a way that the optical path is not connected to the fiber cross-connect switch.
(Supplementary Note A8)
   The communication apparatus according to supplementary note A2 or A5, wherein the node includes a wavelength converter disposed at a preceding stage of the wavelength cross-connect switch.
(Supplementary Note A9)
   The communication apparatus according to supplementary note A8, wherein the node includes a wavelength filter disposed at a preceding stage of the wavelength converter.
(Supplementary Note A10)
   The communication apparatus according to supplementary note A2 or A5, wherein the node includes a controller configured to perform at least one of adding and dropping of the optical path.
(Supplementary Note B1)
   A network configuration system including a plurality of communication apparatuses including a node included in a network configuration in an optical network, wherein
   the node of each communication apparatus includes layers of two or more kinds of different switch granularities, and
   the node of a first communication apparatus connects the layers with respect to the node of an adjacent second communication apparatus.
(Supplementary Note B2)
   The network configuration system according to supplementary note B1, wherein
   the node of each communication apparatus includes
   a wavelength cross-connect layer including a wavelength cross-connect switch configured to perform switching in a wavelength unit, and
   a fiber cross-connect layer including a fiber cross-connect switch configured to perform switching in a fiber unit, and
   each of the wavelength cross-connect switch and the fiber cross-connect switch of the first communication apparatus is connected to an optical path with respect to the node of the second communication apparatus.
(Supplementary Note B3)
   The network configuration system according to supplementary note B2, wherein
   the wavelength cross-connect switch of the first communication apparatus switches in such a way that the optical path is connected to the wavelength cross-connect switch or the fiber cross-connect switch in the second communication apparatus, and
   the fiber cross-connect switch of the first communication apparatus switches in such a way that the optical path is connected to the wavelength cross-connect switch or the fiber cross-connect switch in the second communication apparatus.
(Supplementary Note B4)
   The network configuration system according to supplementary note B2, wherein the wavelength cross-connect switch of the first communication
   apparatus is configured in such a way that the optical path is not connected to the fiber cross-connect switch of the first communication apparatus.
(Supplementary Note B5)
   The network configuration system according to supplementary note B1, wherein
   the node of each communication apparatus includes
   a wavelength cross-connect layer including a wavelength cross-connect switch configured to perform switching in a wavelength unit,
   a wavelength band cross-connect layer including a wavelength band cross-connect switch configured to perform switching of a wavelength band being a bundle of a plurality of wavelengths, and
   a fiber cross-connect layer including a fiber cross-connect switch configured to perform switching in a fiber unit, and
   each of the wavelength cross-connect switch, the wavelength band cross-connect switch, and the fiber cross-connect switch of the first communication apparatus is connected to an optical path with respect to the node of the second communication apparatus.
(Supplementary Note B6)
   The network configuration system according to supplementary note B5, wherein
   the wavelength cross-connect switch of the first communication apparatus switches in such a way that the optical path is connected to any one of the wavelength cross-connect switch, the wavelength band cross-connect switch, and the fiber cross-connect switch in the second communication apparatus,
   the wavelength band cross-connect switch of the first communication apparatus switches in such a way that the optical path is connected to any one of the wavelength cross-connect switch, the wavelength band cross-connect switch, and the fiber cross-connect switch in the second communication apparatus, and
   the fiber cross-connect switch of the first communication apparatus switches in such a way that the optical path is connected to any one of the wavelength cross-connect switch, the wavelength band cross-connect switch, and the fiber cross-connect switch in the second communication apparatus.
(Supplementary Note B7)
   The network configuration system according to supplementary note B5, wherein
   the wavelength cross-connect switch of the first communication apparatus is configured in such a way that the optical path is not connected to the wavelength band cross-connect switch and the fiber cross-connect switch of the first communication apparatus, and
   the wavelength band cross-connect switch of the first communication apparatus is configured in such a way that the optical path is not connected to the fiber cross-connect switch of the first communication apparatus.
(Supplementary Note B8)
   The network configuration system according to supplementary note B2 or B5, wherein the node of each communication apparatus includes a wavelength converter disposed at a preceding stage of the wavelength cross-connect switch.
(Supplementary Note B9)
   The network configuration system according to supplementary note B8, wherein the node of each communication apparatus includes a wavelength filter disposed at a preceding stage of the wavelength converter.
(Supplementary Note B10)
   The network configuration system according to supplementary note B2 or B5, wherein the node of each communication apparatus includes a controller configured to perform at least one of adding and dropping of the optical path.
(Supplementary Note C1)
   A communication method including a step of connecting layers between a node being included in a network configuration in an optical network and including the layers of two or more kinds of different switch granularities, and another adjacent node.
(Supplementary Note C2)
   The communication method according to supplementary note C1, wherein the node includes
   a wavelength cross-connect layer including a wavelength cross-connect switch configured to perform switching in a wavelength unit, and
   a fiber cross-connect layer including a fiber cross-connect switch configured to perform switching in a fiber unit, and,
   in the step of connecting the layers,
   each of the wavelength cross-connect switch and the fiber cross-connect switch is connected to an optical path with respect to the another adjacent node.
(Supplementary Note C3)
   The communication method according to supplementary note C2, wherein,
   in the step of connecting the layers,
   the wavelength cross-connect switch switches in such a way that the optical path is connected to the wavelength cross-connect switch or the fiber cross-connect switch in the another adjacent node, and
   the fiber cross-connect switch switches in such a way that the optical path is connected to the wavelength cross-connect switch or the fiber cross-connect switch in the another adjacent node.
(Supplementary Note C4)
   The communication method according to supplementary note C2, wherein,
   in the step of connecting the layers, the wavelength cross-connect switch is configured in such a way that the optical path is not connected to the fiber cross-connect switch.
(Supplementary Note C5)
   The communication method according to supplementary note C1, wherein
   the node includes
   a wavelength cross-connect layer including a wavelength cross-connect switch configured to perform switching in a wavelength unit,
   a wavelength band cross-connect layer including a wavelength band cross-connect switch configured to perform switching of a wavelength band being a bundle of a plurality of wavelengths, and
   a fiber cross-connect layer including a fiber cross-connect switch configured to perform switching in a fiber unit, and,
   in the step of connecting the layers, each of the wavelength cross-connect switch, the wavelength band cross-connect switch, and the fiber cross-connect switch is connected to an optical path with respect to the another adjacent node.
(Supplementary Note C6)
   The communication method according to supplementary note C5, wherein,
   in the step of connecting the layers,
   the wavelength cross-connect switch switches in such a way that the optical path is connected to any one of the wavelength cross-connect switch, the wavelength band cross-connect switch, and the fiber cross-connect switch in the another adjacent node,
   the wavelength band cross-connect switch switches in such a way that the optical path is connected to any one of the wavelength cross-connect switch, the wavelength band cross-connect switch, and the fiber cross-connect switch in the another adjacent node, and
   the fiber cross-connect switch switches in such a way that the optical path is connected to any one of the wavelength cross-connect switch, the wavelength band cross-connect switch, and the fiber cross-connect switch in the another adjacent node.
(Supplementary Note C7)
   The communication method according to supplementary note C5, wherein,
   in the step of connecting the layers,
   the wavelength cross-connect switch is configured in such a way that the optical path is not connected to the wavelength band cross-connect switch and the fiber cross-connect switch, and
   the wavelength band cross-connect switch is configured in such a way that the optical path is not connected to the fiber cross-connect switch.
(Supplementary Note C8)
   The communication method according to supplementary note C2 or C5, wherein the node includes a wavelength converter disposed at a preceding stage of the wavelength cross-connect switch.
(Supplementary Note C9)
   The communication method according to supplementary note C8, wherein the node includes a wavelength filter disposed at a preceding stage of the wavelength converter.
(Supplementary Note C10)
   The communication method according to supplementary note C2 or C5, wherein the node includes a controller configured to perform at least one of adding and dropping of the optical path.
(Supplementary Note D1)
   A communication program causing a computer to execute a step of connecting layers between a node being included in a network configuration in an optical network and including the layers of two or more kinds of different switch granularities, and another adjacent node.

A part or the whole of the elements described in supplementary note C2 to supplementary note C9 subordinate to supplementary note C1 may also be subordinate to supplementary note D1 in a subordinate relationship similar to supplementary note C1 to supplementary note C9. A part or the whole of the elements described in any supplementary note may be applied to various types of hardware, software, recording means for recording software, systems, and methods.

Further, a communication program for causing a computer to read and execute the above-described communication method is also within the scope of the technical idea of the example embodiments.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The first to third embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. A communication apparatus comprising a node included in a network configuration in an optical network,
wherein the node includes layers of two or more kinds of different switch granularities, and connects the layers with respect to a node of another adjacent communication apparatus.

2. The communication apparatus according to claim 1, wherein
the node includes
a wavelength cross-connect layer including a wavelength cross-connect switch configured to perform switching in a wavelength unit, and
a fiber cross-connect layer including a fiber cross-connect switch configured to perform switching in a fiber unit, and
each of the wavelength cross-connect switch and the fiber cross-connect switch is connected to an optical path with respect to the node of the another adjacent communication apparatus.

3. The communication apparatus according to claim 2, wherein
the wavelength cross-connect switch switches in such a way that the optical path is connected to the wavelength cross-connect switch or the fiber cross-connect switch in the another adjacent communication apparatus, and
the fiber cross-connect switch switches in such a way that the optical path is connected to the wavelength cross-connect switch or the fiber cross-connect switch in the another adjacent communication apparatus.

4. The communication apparatus according to claim 2, wherein the wavelength cross-connect switch is configured in such a way that the fiber cross-connect switch and the optical path are not connected to each other.

5. The communication apparatus according to claim 1, wherein
the node includes
a wavelength cross-connect layer including a wavelength cross-connect switch configured to perform switching in a wavelength unit,
a wavelength band cross-connect layer including a wavelength band cross-connect switch configured to perform switching of a wavelength band being a bundle of a plurality of wavelengths, and
a fiber cross-connect layer including a fiber cross-connect switch configured to perform switching in a fiber unit, and
each of the wavelength cross-connect switch, the wavelength band cross-connect switch, and the fiber cross-connect switch is connected to an optical path with respect to the node of the another adjacent communication apparatus.

6. The communication apparatus according to claim 5, wherein
the wavelength cross-connect switch switches in such a way that the optical path is connected to any one of the wavelength cross-connect switch, the wavelength band cross-connect switch, and the fiber cross-connect switch in the another adjacent communication apparatus,
the wavelength band cross-connect switch switches in such a way that the optical path is connected to any one of the wavelength cross-connect switch, the wavelength band cross-connect switch, and the fiber cross-connect switch in the another adjacent communication apparatus, and
the fiber cross-connect switch switches in such a way that the optical path is connected to any one of the wavelength cross-connect switch, the wavelength band cross-connect switch, and the fiber cross-connect switch in the another adjacent communication apparatus.

7. The communication apparatus according to claim 5, wherein
the wavelength cross-connect switch is configured in such a way that the optical path is not connected to the wavelength band cross-connect switch and the fiber cross-connect switch, and
the wavelength band cross-connect switch is configured in such a way that the optical path is not connected to the fiber cross-connect switch.

8. The communication apparatus according to claim 2, wherein the node includes a wavelength converter disposed at a preceding stage of the wavelength cross-connect switch.

9. The communication apparatus according to claim 8, wherein the node includes a wavelength filter disposed at a preceding stage of the wavelength converter.

10. The communication apparatus according to claim 2, wherein the node includes a controller configured to perform at least one of adding and dropping of the optical path.

11. A network configuration system comprising a plurality of communication apparatuses including a node included in a network configuration in an optical network, wherein
the node of each communication apparatus includes layers of two or more kinds of different switch granularities, and
the node of a first communication apparatus connects the layers with respect to the node of an adjacent second communication apparatus.

12. The network configuration system according to claim 11, wherein
the node of each communication apparatus includes
a wavelength cross-connect layer including a wavelength cross-connect switch configured to perform switching in a wavelength unit, and
a fiber cross-connect layer including a fiber cross-connect switch configured to perform switching in a fiber unit, and
each of the wavelength cross-connect switch and the fiber cross-connect switch of the first communication apparatus is connected to an optical path with respect to the node of the second communication apparatus.

13. The network configuration system according to claim 12, wherein
the wavelength cross-connect switch of the first communication apparatus switches in such a way that the optical path is connected to the wavelength cross-connect switch or the fiber cross-connect switch in the second communication apparatus, and
the fiber cross-connect switch of the first communication apparatus switches in such a way that the optical path is connected to the wavelength cross-connect switch or the fiber cross-connect switch in the second communication apparatus.

14. The network configuration system according to claim 12, wherein the wavelength cross-connect switch of the first communication apparatus is configured in such a way that the optical path is not connected to the fiber cross-connect switch of the first communication apparatus.

15. The network configuration system according to claim 11, wherein
the node of each communication apparatus includes
a wavelength cross-connect layer including a wavelength cross-connect switch configured to perform switching in a wavelength unit,
a wavelength band cross-connect layer including a wavelength band cross-connect switch configured to perform switching of a wavelength band being a bundle of a plurality of wavelengths, and
a fiber cross-connect layer including a fiber cross-connect switch configured to perform switching in a fiber unit, and
each of the wavelength cross-connect switch, the wavelength band cross-connect switch, and the fiber cross-connect switch of the first communication apparatus is connected to an optical path with respect to the node of the second communication apparatus.

16. The network configuration system according to claim 15, wherein
the wavelength cross-connect switch of the first communication apparatus switches in such a way that the optical path is connected to any one of the wavelength cross-connect switch, the wavelength band cross-connect switch, and the fiber cross-connect switch in the second communication apparatus,
the wavelength band cross-connect switch of the first communication apparatus switches in such a way that the optical path is connected to any one of the wavelength cross-connect switch, the wavelength band cross-connect switch, and the fiber cross-connect switch in the second communication apparatus, and
the fiber cross-connect switch of the first communication apparatus switches in such a way that the optical path is connected to any one of the wavelength cross-connect switch, the wavelength band cross-connect switch, and the fiber cross-connect switch in the second communication apparatus.

17. The network configuration system according to claim 15, wherein
the wavelength cross-connect switch of the first communication apparatus is configured in such a way that the optical path is not connected to the wavelength band cross-connect switch and the fiber cross-connect switch of the first communication apparatus, and
the wavelength band cross-connect switch of the first communication apparatus is configured in such a way that the optical path is not connected to the fiber cross-connect switch of the first communication apparatus.

18. The network configuration system according to claim 12, wherein the node of each communication apparatus includes a wavelength converter disposed at a preceding stage of the wavelength cross-connect switch.

19. The network configuration system according to claim 18, wherein the node of each communication apparatus includes a wavelength filter disposed at a preceding stage of the wavelength converter.

20. A communication method comprising a step of connecting layers between a node being included in a network configuration in an optical network and including the layers of two or more kinds of different switch granularities, and another adjacent node.
